(19) United States
(12) Patent Application Publication
(10) Pub. No.: US 2007/0031182 A1
(43) Pub. Date: Feb. 8, 2007

(54) Adhesive bracelets

(76) Inventors: Kelli Widdefield, Dayton, OH (US); Theresa Moll, Dayton, OH (US)

Correspondence Address: THOMPSON HINE L.L.P., P.O. BOX 8801, DAYTON, OH, 45401-8801, US

(21) Appl. No.: 11/195,137

(22) Filed: Aug. 2, 2005

(51) Int. Cl. B42F 13/00

(52) U.S. Cl. 402/79

(57) ABSTRACT

An assembly including a plurality of strips located immediately adjacent to each other. Each strip has an outer surface made at least partially of a generally water-absorbent material such that each strip can be easily written upon. Each strip has an adhesive portion that can be attached to another portion of the strip after the strip is separated from the assembly to thereby form a closed loop.

The present invention is directed to a strip of material which can be written upon and formed into a closed loop and adhered to itself to retain the loop shape.

### BACKGROUND

Notebooks, binders and the like are widely used by students, professionals and other users in lectures, classrooms, business meetings, etc. During the use of such materials, it is often desired to make a written notation or reminder. For example, with existing components a user may write a reminder in the margin of a notebook, on a loose piece of paper, etc. However, such written reminders can be easily overlooked, misplaced or lost. Users may also desire to make written reminders in a variety of other settings. Accordingly, there is a need for an improved device and method for making written reminders.

### SUMMARY

In one embodiment the present invention is a method and device for making written reminders which reduces the chances of the reminder being overlooked, misplaced or lost. In particular, in one embodiment the invention is an assembly including a plurality of strips located immediately adjacent to each other. Each strip has an outer surface made at least partially of a generally water-absorbent material such that each strip can be written upon. Each strip has an adhesive portion that can be attached to another portion of the strip after the strip is separated from the assembly to thereby form a closed loop.

### BRIEF DESCRIPTION OF THE DRAWINGS

FIG. 1 is a front perspective view of a sheet including a plurality of strips formed therein;

FIG. 2 is a front perspective view of the sheet of FIG. 1 bound into a notebook;

FIG. 3 is a side perspective detail view of part of the notebook of FIG. 2, with a reminder being written thereon;

FIG. 4 is a top view of a strip of the notebook of FIG. 3 removed from the sheet;

FIG. 5 is a front perspective view of the strip of FIG. 4, wrapped around the wrist of a user;

FIG. 6 is a front perspective view of the strip of FIG. 5, attached to itself to form a loop or bracelet;

FIG. 7 is a top view of another sheet including a plurality of strips formed therein;

FIG. 8 is a perspective view of an notebook including a plurality of sheets and strips bound together, illustrating how the sheet of FIG. 7 may be bound thereto;

FIG. 9 is a front perspective view of the notebook of FIG. 8;

FIG. 10 is a front perspective view of the notebook of FIG. 9, illustrating one of the strip lifted slightly upwardly and slightly bowed;

FIG. 11 is a front perspective view of the notebook of FIG. 10, with the strip separated from the notebook; and

FIG. 12 is a front perspective view of the notebook and strip of FIG. 11, with the strip unfolded and laid flat.

### DETAILED DESCRIPTION

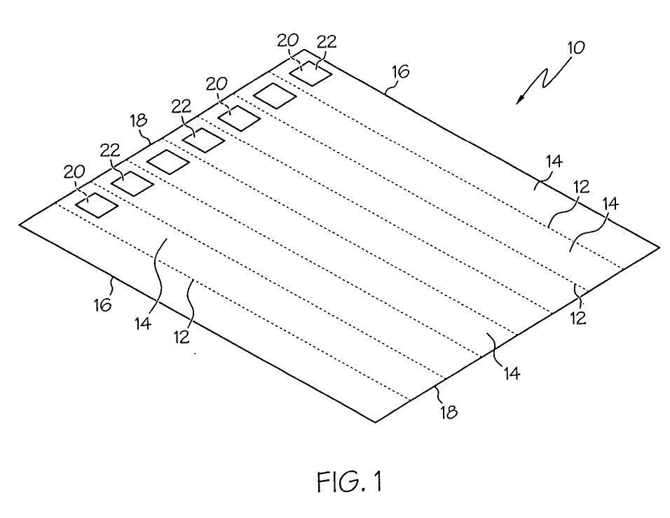

As shown in FIG. 1, in one embodiment the present invention is a sheet of material 10 having a plurality of tear guidelines 12 which define a plurality of strips 14 in the sheet. The tear guidelines 12 can be any of a variety of features which permit tearing therealong, including but not limited to perforations, creases, score lines, score-slit lines, combinations of these features and the like. The sheet 10/strips 14 can be made of a variety of materials, in one case the sheet 10/strips 14 have a thickness of between about 0.003 inches and about 0.0175 inches. The sheet 10/strips 14 may be made of a single ply, generally water-absorbent material such as cellulose-based or pulp-based paper such that the sheet 10 can be written upon by a wide variety of writing instruments, such as pens, pencils, markers, etc.

The sheet 10/strips 14 may also be made of double-ply or multiple-ply sheet. In this case the upper or outer ply (or a part thereof) can be made of a generally water-absorbent material, such as cellulose-based or pulp-based paper to provide a writing portion. The writing portion may make up a majority of the upper or outer ply. The sheet 10/strip 14 may also have a backing ply of a plastic or polymer material, such as polyethylene, polyproplyne, etc., to lend strength and durability to the strips 14. Each of the plies may be permanently coupled together such that they cannot be separated without damaging the sheet 10/strips 14 or the individual plies.

The sheet 10 may be generally rectangular in top view and can have any of a variety of dimensions, for example, about 8½ inches by about 11 inches. The sheet 10 may include a pair of longitudinal edges 16 and a pair of free or lateral edges 18. In the illustrated embodiment each tear guideline 12 extends from one of the lateral edges 18 to the other opposed lateral edge 18. Thus, in the illustrated embodiment, the tear guidelines 12 extend generally parallel to the longitudinal edges 16 or length of the sheet 10. However, if desired, the tear guidelines 12 can extend laterally across the sheet 10 or in any of a variety of other directions. Thus, the tear guidelines 12 may extend across the entire length or width of the sheet 10, or from one portion of the outer perimeter (16, 18) to another portion.

Each strip 14 may be nested next to any adjacent strip 14 such that there is generally no waste material (i.e., no portions of the sheet 10) located between each adjacent strip 14. For example, in the illustrated embodiment, each strip 14 is generally rectangular in top view and has a generally uniform width. The strips 14 may take a variety of other shapes besides rectangular, but may be configured such that the strips 14 remain nested in whatever shape they take.

Each strip 14 may have an adhesive portion or adhesive material 20 located thereon, for example, at or adjacent to one of the ends or lateral edges 18 of the strip 14. In the illustrated embodiment, the adhesive portion 20 is a pressure sensitive adhesive covered by a removable release liner 22. However, if desired, the adhesive portion 20 may not include a releasable liner 22, in which case the adhesive portion 20 could be moisture activated or the like.

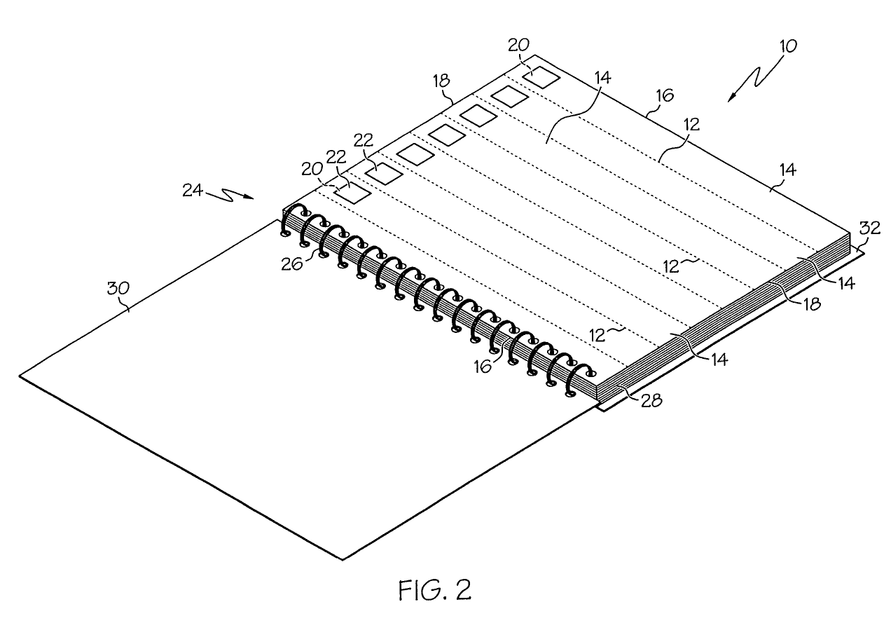

As shown in FIG. 2, the sheet 10 may be bound into a notebook 24 by a binding mechanism 26, such as a coil binding mechanism, spiral binding mechanism, three-hole prong binding mechanism, adhesive binding mechanism, etc. The sheet 10 may be bound to a plurality of papers 28 by the binding mechanism 26. The papers 28 may be standard papers which lack the perforation, strips, etc. of the sheet 10 and may be used for writing, taking notes, etc. If desired, the papers 28 may have the same size and shape as the sheet 10, as shown in FIG. 2. The notebook 24 may include a top cover 30 and a bottom cover 32 having a greater thickness and/or stiffness than the papers 28/sheet 10 to protect the contents of the notebook 24. The covers 30, 32 are thereby movable to a closed position wherein the covers 30, 32 generally cover all of the strips 14. The covers 30, 32 can be made of a variety of materials, including but not limited to cardboard, paperboard, plastic or polymer materials, etc.

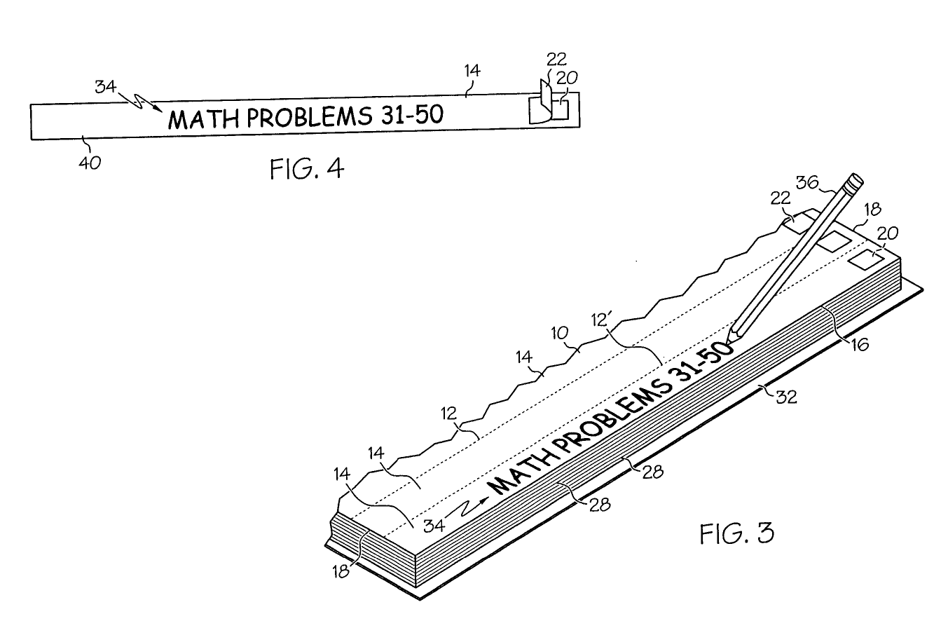

In order to utilize the strips 14, when a user wishes to create a reminder the user manually rites indicia 34, such as text, on one of the strips 14 with a writing instrument 36, as shown in FIG. 3. The upper or outer ply (or writing portion) is thus written upon by the writing instrument 36. In FIG. 3, the writing portion is shown as being located on the same side as the adhesive portion 20. If desired, however, the writing portion can be located on the opposite side of the strip 14 relative to the adhesive portion 20. After being written upon the sheet 10 is then torn along perforation line 12′ of FIG. 3 to remove the strip 14 from the notebook 24/sheet 10 (FIG. 4). Alternately, rather than writing the indicia 34 when the strip 14 is bound in the notebook 24, the indicia 34 can be written after the strip 14 is removed from the sheet 10/notebook 24.

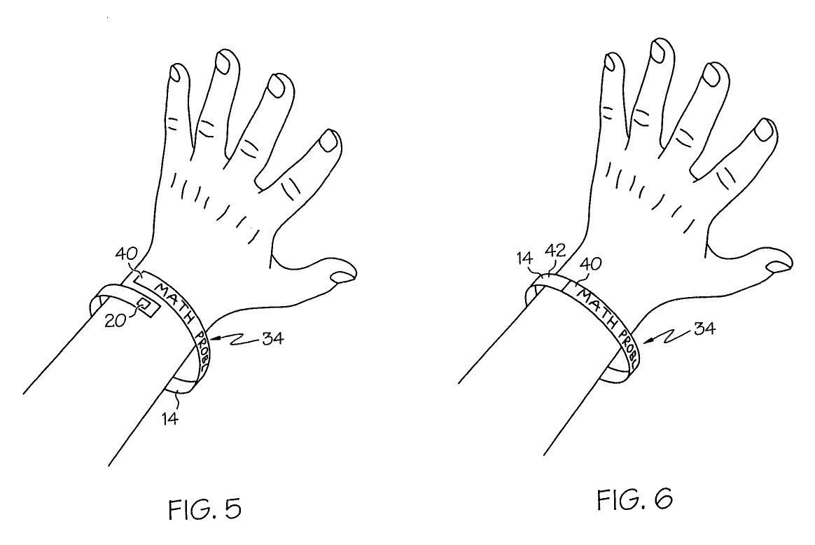

The strip 14 is then placed on or adjacent to the wrist or other body part of the user and wrapped around the wrist or body part to form a generally closed loop, as shown in FIG. 5. The strip 14 may be wrapped around the wrist of the user such that that indicia 34 faces outwardly so that the indicia 34 is always visible. Alternately, the strip 14 may be wrapped such that the indicia 34 faces inwardly to protect the indicia 34. The adhesive portion 20 is then activated or exposed, such as by removing the liner 22 (as shown in FIG. 4). The distal end 40 of the strip 14 is pressed into contact with the adhesive portion 20 to form a closed loop or bracelet 42 as shown in FIG. 6. If desired, any overlapping material of the strip 14 adjacent to the distal end 40 can be trimmed and removed. In addition, rather than utilizing the strip 14 on a part of the body, the strip 14 can be wrapped around another component, such as a backpack strap or loop, briefcase handle, etc.

The adhesive portion 20 may be made of a variety of adhesive materials which allow the strip 14 to be held in its “loop” position. For example, the adhesive portion 20 may be made of a relatively weak adhesive (such as the adhesive used in POST-IT® adhesive notes sold by 3M of St. Paul, Minn.) which allows the attachment portion 20 to be separated from the portion 40 of the strip to which it is attached to allow the bracelet 42 to be removed without tearing. Alternately, the adhesive portion 20 may be relatively strong (i.e., stronger than the material of the strip 14) such that the bracelet 42 may be removed only by tearing the material of the strip 14. Each strip 14 may be generally flat and planar, and lack any other mechanisms (i.e., snaps, rivets, or other mechanical fasteners) for retaining the strip 14 in its loop configuration.

Each strip 14 should have sufficient length to be formed into a loop around the wrist of a user. Thus, the length of the strips 14 may vary depending upon the age and size of the intended user. As outlined above, when the strips 14 are formed as longitudinal strips in standard eight and one-half inch by eleven inch sheets 10, the strips 14 may have a length of at least about eleven inches which should be sufficient for the majority of users. However, if desired, the strips 14 may have a shorter length, as low as at least about eight inches. Each strip 14 may have a width of between about one-half inch and about one and one-half inches, and more particularly about one inch. Each strip 14 should have a width that is sufficient to provide sufficient strength to the strip 14, and to provide sufficient surface area for writing thereupon. Each strip 14 may have indicia printed thereon, such as colors areas, text, ruled lines, etc. to guide a user in his or her writing. In one embodiment about ½ of the surface area of one side of each strip is printed with a relatively dark color (which may dissuade a user from writing on that area) and the remaining surface area of the side is white or a light color to encourage writing thereon.

In this manner, once the bracelet or loop 42 is formed on the wrist of the user, the strip 14 and written indicia 34 are carried with the user until the user removes the strip 14/bracelet 42. This method of creating reminders can replace writing on the user's hand or wrist with ink or the like, which is a technique practiced by many students. The use of the strips 14 of the present invention provides a much easier and more convenient method of creating reminders. In addition, the strips 14 can be easily disposed of, as compared to significant scrubbing often required to remove writing from a user's hand or wrist.

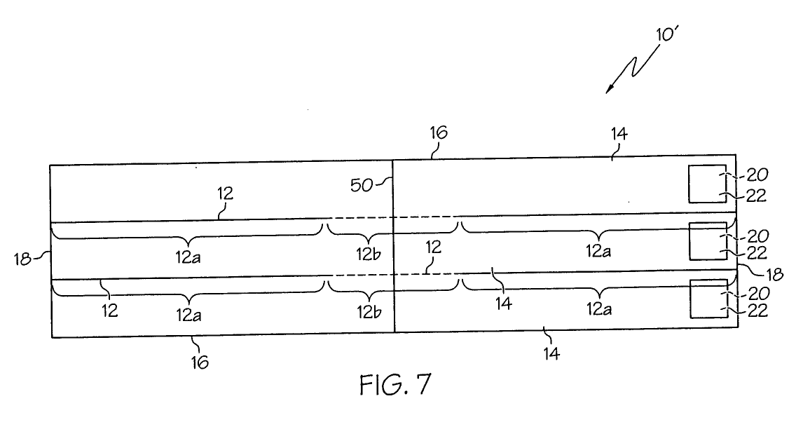

FIG. 7 illustrates another sheet 10′ similar to the sheet 10 described above. In particular, the sheet 10′ (and the associated strips 14) can have the same properties and be made of the same materials (including single ply and multiple-ply materials) described above for the sheet 10 and associated strips 14. The sheet 10′ may also have a length similar to the sheet 10 such that the strips 14 of sheet 10′ are sufficiently long to wrap around the wrist of a user. However, in the embodiment shown in FIG. 7, the sheet 10′ includes only three strips 14 to provide a sheet 10′ having a relatively small width (i.e. having width of between about two inches and about four inches, and more particularly about three inches).

The sheet 10′ includes a fold line 50 which is located at or adjacent to the longitudinal center line of the sheet 10′/strips 14, and will be described in greater detail below. The tear guidelines 12 of the sheet 10′ may include two portions 12a and 12b. In the illustrated embodiment portions 12a are score lines or slit lines which extend entirely through the thickness of the sheet 10′. The portions 12a of each strip 14 may constitute the majority of the length of each tear guidelines 12 such that the majority of each longitudinal edge of each strip 14 is free and not directly coupled to any other strip or component. Portions 12b are perforation lines, or score/slit lines that do not extend entirely through the thickness of the sheet 10′. Portions 12b of the tear guidelines are located at or adjacent to the fold line 50 and serve to couple the strips 14 together at or adjacent to the fold line 50.

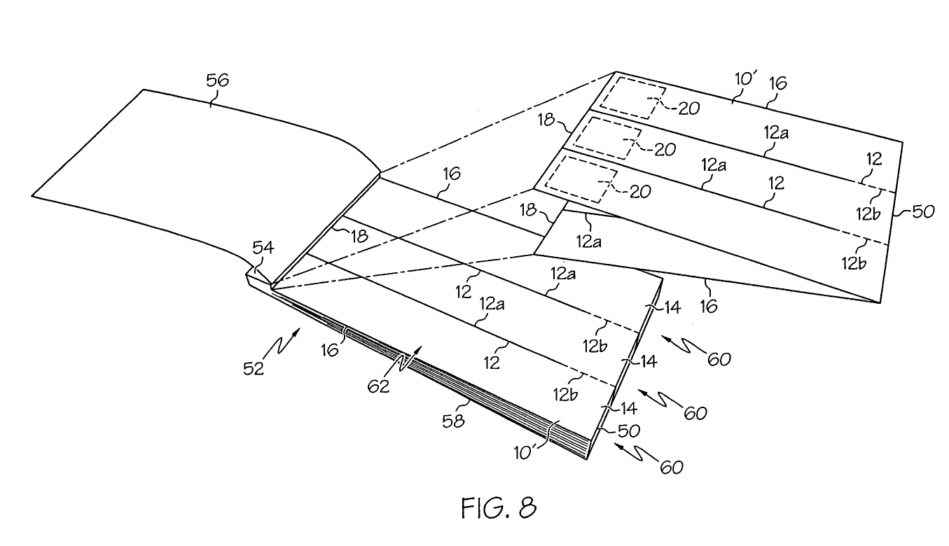

The sheet 10′, or a plurality of sheets 10′, can be bound together to form a notebook/assembly 52. For example, as shown in FIG. 8, the sheet 10′ of FIG. 7 is folded inwardly about fold line 50 until the sheet 10′ is folded into a two-ply configuration wherein the lateral edges 18 are aligned. In the configuration shown in FIG. 8 the sheet 10′ is folded such that the adhesive portions 20 are facing inwardly which can help to protect the adhesive portions 20. However, the sheet 10′ could be folded in the opposite direction such that the adhesive portions 20 are facing outwardly. In addition, the sheet 10′ can be folded in a variety of other configurations.

After being folded into the configuration shown in FIG. 8 both lateral edges 18 may then be bound to the notebook 52 by a binding mechanism 54. In the illustrated embodiment the binding mechanism is an adhesive binding mechanism, although the binding mechanism 54 could be a coil binding mechanism, spiral binding mechanism, three-hole prong binding mechanism, etc. In addition, the folded sheet 10′ can be bound along fold line 50, or along other edges thereof as desired. If desired the sheet 10′ can be bound along a tear guideline to allow the sheet 10′/strips 14 to be removed.

A plurality of sheets 10′ may be bound together to form the notebook 52. The notebook 52 may include a top cover 56 and a bottom cover 58 to lend support and provide protection to the contents of the notebook 52. Each cover 56, 58 may have a greater thickness and/or stiffness than the sheet of material 10′/strips 14 to protect the contents of the notebook 52, and can be made of a variety of materials, including but not limited to cardboard, paperboard, plastic or polymer materials, etc.

When a plurality of sheets 10′ are bound together, the notebook 52 may include a plurality of stacks 60 and rows 62 of strips 14. For example, the illustrated notebook 52 may include three separate stacks 60 of strips 14, wherein each stack 60 comprises a plurality of strips 14 generally vertically aligned and stacked on top of each other. The stacks 60 are laterally arranged such that the stacks 60 are in a side-by-side configuration (and such that the adjacent strips 14 are in a side-by-side configuration).

The notebook 52 may also include a plurality of horizontally arranged rows 62 of strips 14 (i.e. each row 62 may comprises the strips 14 of a single sheet 10′). However, it should be understood that each strip 14 in a row 62 need not necessarily be coupled to any adjacent strips 14 in that row 62. In addition, each strip 14 in a row 62 need not necessarily be formed from a single sheet (i.e. a sheet 10′). Instead each strip 14 could be independently formed and bound into the notebook 52. In either case, the strips 14 may be bound in a loose-leaf manner; i.e. each strip 14 is bound along a common, aligned edge or surface and not in a concertina or accordion-style (wherein opposed edges of the sheets or strips are bound to other sheets or strips).

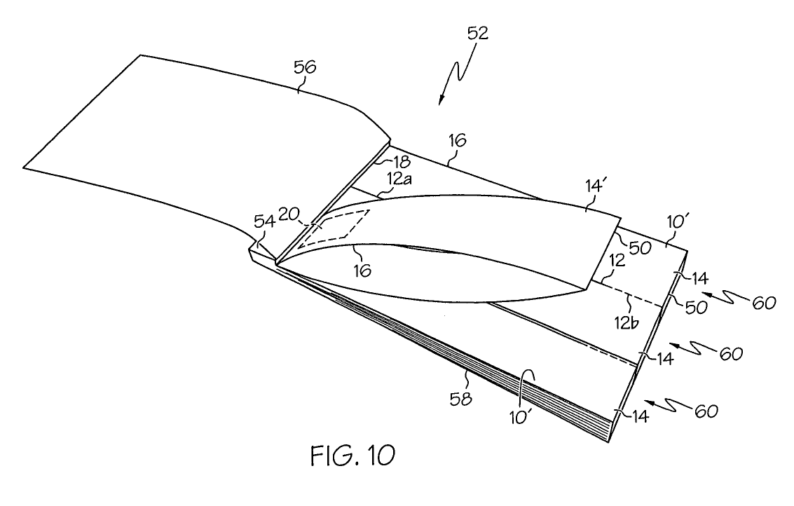

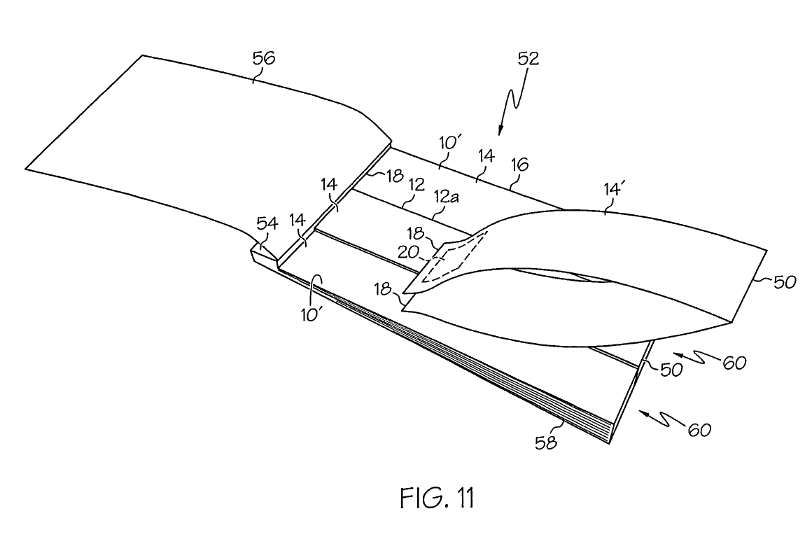

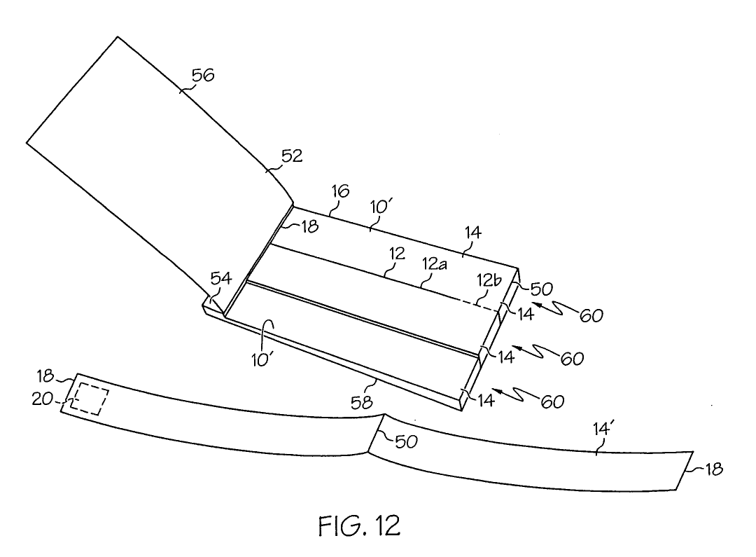

As shown in FIG. 10, when a single strip 14′ is bound to the notebook 52 at both lateral ends 18 the strip 14′ forms a flat, folded loop. The strip 14′ of FIG. 10 is separated from the adjacent strip by tearing the tear guide 12b between two strips. In order to utilize the strip 14′, the lateral ends 18 are separated from the notebook 52/binding mechanism 54. For example, as outlined above in one case the lateral ends 18 are coupled to the notebook 52/binding mechanism 54 by a tear guide line, such as a line of perforations. Thus each lateral end 18 may be releasably coupled to the notebook 52/binding mechanism 54. After the lateral ends 18 are separated from the notebook 52/binding mechanism 54 (FIG. 11), the strip 14′ can then be unfolded and laid flat, as shown in FIG. 12. The strip 14′ can then be written upon and formed into a loop around the wrist of a user, as described above and shown in FIGS. 4-6.

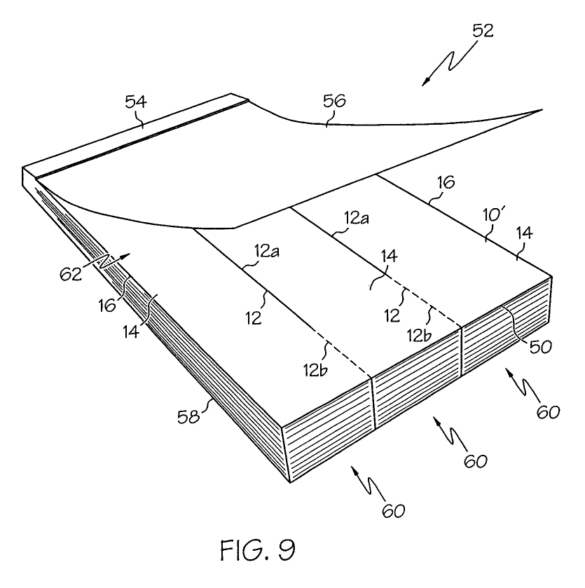

The notebook 52 of FIGS. 8-12 provides a relatively small, compact arrangement for storing and dispensing the strips 14. In particular, because the strips 14 are folded, and only three rows of strips 14 are provided, the notebook 52 can be sized to be relatively small (i.e. between about two and about four inches wide, and between about four and about six inches long, and more particularly about three inches wide by about five inches long) such that the notebook 52 can be easily stored in a clothing pocket, in a binder or folder storage pocket, etc.

In this manner, notebook 52 can be easily carried by a user wherever needed. In addition, if desired writing paper or notepaper can also be bound in the notebook 52. In this case the bound paper may have about the same size as one of the covers 56, 58, or the size of a folded sheet 10′. The bound papers can be located either above or below the strips 12.

Having described the invention in detail and by reference to the preferred embodiments, it will be apparent that modifications and variations thereof are possible without departing from the scope of the invention.

What is claimed is:

1. An assembly comprising a plurality of strips located immediately adjacent to each other, each strip having an outer surface made at least partially of a generally water-absorbent material such that each strip can be written upon, and wherein each strip has an adhesive portion that can be attached to another portion of said strip after said strip is separated from said assembly to thereby form a closed loop.

2. The assembly of claim 1 wherein each strip includes a pair of opposed longitudinal edges, and wherein each strip has a longitudinal edge located immediately adjacent to the longitudinal edge of an adjacent strip.

3. The assembly of claim 2 wherein a longitudinal edge of each strip is directly coupled to the longitudinal edge of an adjacent strip.

4. The assembly of claim 2 wherein each strip has a pair of opposed lateral edges having a shorter length than said longitudinal edges.

5. The assembly of claim 4 wherein each strip is generally rectangular in top view.

6. The assembly of claim 1 wherein each strip has a generally uniform width.

7. The assembly of claim 1 wherein said plurality of strips located immediately adjacent to each other includes at least two strips located in a side-by-side configuration to form a row of strips.

8. The assembly of claim 7 wherein said at least two strips are nested such that there is no material located between said at least two strips.

9. The assembly of claim 7 further comprising a supplemental row of strips located above or below said row of strips.

10. The assembly of claim 1 wherein said plurality of strips located immediately adjacent to each other includes at least one strip stacked on top of another strip.

11. The assembly of claim 10 wherein said stacked strips are generally aligned to form a stack of bound strips.

12. The assembly of claim 11 further comprising a supplemental stack of bound strips located immediately adjacent to said stack of bound strips.

13. The assembly of claim 1 wherein said plurality of strips are bound together.

14. The assembly of claim 13 further comprising a binding mechanism binding said plurality of strips together.

15. The assembly of claim 13 wherein said strips are bound in loose-leaf configuration such that common edges of said strips are bound together.

16. The assembly of claim 1 wherein each strip is coupled to said assembly along a tear guide line.

17. The assembly of claim 1 wherein each strip is folded upon itself to form a two-ply strip.

18. The assembly of claim 17 wherein each strip is folded at or adjacent to a longitudinal center thereof.

19. The assembly of claim 17 wherein each strip folded about a fold line and is coupled to an adjacent strip at or adjacent to said fold line.

20. The assembly of claim 17 wherein each strip includes two generally aligned lateral ends, and wherein each end is releasably coupled to said assembly.

21. The assembly of claim 1 wherein each strip includes a pair of longitudinal edges, and wherein the majority of each longitudinal edge is free and not directly coupled to any other component.

22. The assembly of claim 1 further comprising a cover bound to said strips.

23. The assembly of claim 22 wherein said cover is movable to a closed position wherein said generally covers all of said bound strips.

24. The assembly of claim 1 wherein said adhesive portion includes a release liner located thereon.

25. The assembly of claim 1 wherein said generally water-absorbent material is made of a cellulose-based or pulp-based paper material.

26. The assembly of claim 1 wherein said generally water absorbent material covers the majority of the surface area of said outer surface.

27. The assembly of claim 1 wherein each strip has a total length of at least about 8 inches.

28. The assembly of claim 1 wherein said immediately adjacent strips are formed in a common sheet of material.

29. The assembly of claim 28 wherein each strip is defined by at least one tear guideline in said sheet.

30. The assembly of claim 29 wherein said at least one tear guideline includes a perforated line.

31. The assembly of claim 28 wherein said sheet of material is folded about itself to form a two-ply sheet of material.

32. An assembly comprising a plurality of strips that are bound together, each strip having at least one longitudinal edge and having an adhesive portion that can be attached to another portion of said strip after said strip is separated from said assembly to thereby form a closed loop, wherein at least two of said strips are located immediately adjacent to each other along said longitudinal edges in a side-by-side configuration to form a row of bound strips.

33. A sheet of material including a plurality of tear guidelines which define a plurality of strips which are nested along a longitudinal direction thereof, wherein each strip has an adhesive portion that can be attached to another portion of said strip after said strip is separated from said sheet to thereby form a closed loop.

34. An assembly comprising a plurality of strips, each strip having an adhesive portion that can be attached to another portion of said strip after said strip is separated from said assembly to thereby form a closed loop, wherein each strip is folded upon itself to form a two-ply strip.

35. A method for manipulating a sheet of material comprising the steps of:
providing an assembly including a plurality of strips, wherein each strip has generally water absorbent portion and an adhesive portion;
manually writing indicia on the generally water absorbent portion of one of said strips;
separating said one of said strips from said assembly;
forming said one of said strips into a generally looped configuration; and
pressing said adhesive portion of said one of said strips into contact with another portion of said one of said strips such that said adhesive portion retains said one of said strips in said looped configuration.
